(19) United States
(12) Patent Application Publication
(10) Pub. No.: US 2026/0272741 A1
(43) Pub. Date: Sep. 17, 2026

(54) KNEE SUPPORT ASSEMBLY FOR A WHEELCHAIR

(71) Applicant: PERMOBIL AB, Sundsvall (SE)

(72) Inventor: Niklas YTTERSTRÖM, Sundsvall (SE)

(21) Appl. No.: 19/473,751

(22) PCT Filed: Apr. 10, 2024
(86) PCT No.: PCT/EP2024/059674

§ 371 Date: Oct. 8, 2025

(30) Foreign Application Priority Data
Apr. 11, 2023 (EP) 23167279.1

(51) Int. Cl. A61G 5/12; A61G 5/14

(52) U.S. Cl. CPC A61G 5/127; A61G 5/14; A61G 2203/70

(57) ABSTRACT

A knee support assembly (1) for a wheelchair, comprising: a knee support (3) comprising: a base bracket assembly (3a) configured to be mounted to a wheelchair (21), a first harness holder (3b) having a lower portion connected to the base bracket assembly (3a) at a first lateral side of the base bracket assembly (3a), a second harness holder (3c) having a lower portion connected to the base bracket assembly (3a) at a second lateral side of the base bracket assembly (3a), a flexible harness (3d) connected to and extending between the first harness holder (3b) and the second harness holder (3c), wherein the flexible harness (3d) is arranged to provide knee support, wherein at least one of the first harness holder (3b) and the second harness holder (3c) is releasably connected to the base bracket assembly (3a), to enable moving the flexible harness to the side relative to the base bracket assembly (3a) and thereby allow placement or removal of a leg between the base bracket assembly (3a) and the flexible harness (3d).

### TECHNICAL FIELD

The present disclosure generally relates to wheelchairs.

### BACKGROUND

Wheelchairs may be equipped with knee supports to support the knees and lower legs of the user. This is useful both when the user sits in the wheelchair and in case the user attains a standing position in a wheelchair with vertical stand capability. Keeping the knees/legs supported and in position, and thereby keeping the user's lower body in position, has a beneficial impact to a user's general posture and well-being, both in sitting, standing and forward tilt positions.

US 2021/0161742 A1 discloses a knee support system to be incorporated within a mobility apparatus. The knee support system comprises at least two oppositely positioned knee supports configured to be connected to members of the mobility apparatus, wherein the knee supports have a disengaged position in which the knee supports are laterally rotated and an engaged position in which the knee supports are harnessing legs of a user.

The solution disclosed in US 2021/0161742 A1 does not appear simple to engage and unlock, especially for users with certain physical impairments. Moreover, the seat becomes significantly wider when the knee supports are rotated laterally. Additionally, while the knee supports do have padding over the rigid brackets, if the padding eventually wears down or becomes compressed and thereby hardened, this may result in poor performance and significant discomfort to the user.

### SUMMARY

A general object of the present disclosure is to provide a knee support assembly for a wheelchair which solves or at least mitigates the problems of the prior art.

There is hence according to a first aspect of the present disclosure provided a knee support assembly for a wheelchair, comprising: a knee support comprising: a base bracket assembly configured to be mounted to a wheelchair, a first harness holder having a lower portion connected to the base bracket assembly at a first lateral side of the base bracket assembly, a second harness holder having a lower portion connected to the base bracket assembly at a second lateral side of the base bracket assembly, a flexible harness connected to and extending between the first harness holder and the second harness holder, wherein the flexible harness is arranged to provide knee support, wherein at least one of the first harness holder and the second harness holder is releasably connected to the base bracket assembly, to enable moving the flexible harness to the side relative to the base bracket assembly and thereby allow placement or removal of a leg between the base bracket assembly and the flexible harness.

The flexible harness provides less load on the user's knee and upper portion of its lower leg due to its mechanical flexibility and it being arranged in a suspended state. The harness structure also makes the flexible harness easy to fold to the side when a user transfers into or out of the wheelchair or simply desires to release the knee support assembly. Moreover, the flexible harness provides self-alignment towards the knee and lower leg because of the harness type design and is easier to handle due to its lower weight.

According to one embodiment the knee support is a first knee support and the knee support assembly comprises a second knee support comprising: a base bracket assembly configured to be mounted to a wheelchair, a first harness holder having a lower portion connected to the base bracket assembly at a first lateral side of the base bracket assembly, a second harness holder having a lower portion connected to the base bracket assembly at a second lateral side of the base bracket assembly, a flexible harness connected to and extending between the first harness holder and the second harness holder, wherein the flexible harness is arranged to provide knee support, wherein at least one of the first harness holder and the second harness holder is releasably connected to the base bracket assembly, to enable moving the flexible harness to the side relative to the base bracket assembly and thereby allow placement or removal of a leg between the base bracket assembly and the flexible harness.

The base bracket assembly of the first knee support and the second knee support may be two different base bracket assemblies, or they may be a single common base bracket assembly. Additionally, the first and second harness holder may be connected to a single member of the base bracket assembly, or to separate members of the base bracket assembly.

According to one embodiment the first knee support is a right knee support, and the second knee support is a left knee support.

According to one embodiment for each of the right knee support and the left knee support, the first harness holder is an outer harness holder, and the second harness holder is an inner harness holder.

According to one embodiment each inner harness holder is releasably connected to the respective base bracket assembly.

According to one embodiment for each of the first and the second knee support, both the first harness holder and the second harness holder is releasably connected to the respective base bracket assembly.

According to one embodiment for each knee support, the at least one of the first harness holder and the second harness holder that is releasably connected to the base bracket assembly comprises a locking mechanism configured to releasably lock said harness holder to the base bracket assembly.

According to one embodiment the locking mechanism comprises a spring-loaded element configured to engage with the base bracket assembly, and a release member configured to disengage the spring-loaded element from the base bracket assembly base bracket assembly. The knee support may thus be secured and unsecured with reduced effort by the user.

According to one embodiment the spring-loaded element is a pivotable element urged to pivot into engagement with the base bracket assembly by spring tension.

According to one embodiment for each knee support the flexible harness comprises a user-adjustable adjustment system configured to adjust a size and/or a tightness of the flexible harness.

According to one embodiment the adjustment system comprises an external knob, and a wire connected to the external knob and arranged inside the flexible harness, wherein the external knob is configured to adjust the length of the wire by rotation, a push, or a pull of the external knob, causing an adjustment of a distance between opposite ends of the flexible harness, configured to be connected to a respective one of the first harness holder and the second harness holder, thereby adjusting the tightness of the flexible harness.

According to one embodiment the adjustment system comprises a connection strap comprising a first strap piece and a second strap piece, each strap piece being configured to be connected to a respective one of the first harness holder and the second harness holder, wherein one of the strap pieces is configured to slide axially relative to the other strap piece, and wherein the adjustment system comprises a main strap connecting and extending between the first and the second strap piece, the main strap having an excess length relative to a minimum distance between the first strap piece and the second strap piece, wherein the first strap piece is connected to the external knob and the main strap is connected to the wire, and wherein the length of the wire determines a distance between the two strap pieces, and thereby the distance between the opposite ends of the flexible harness.

According to one embodiment the flexible harness comprises a substrate provided with a slot in which the said strap piece of the connection strap.

According to one embodiment the adjustment system comprises a binding system or a tightening strap for adjustment of the size or tightness of the flexible harness.

According to one embodiment the adjustment system is a fine adjustment system providing fine adjustment of the distance, and wherein the knee support assembly comprises a coarse adjustment system providing coarse adjustment of the distance.

According to each flexible harness is pivotally connected to first harness holder and to the second harness holder. Thus, each flexible harness becomes self-aligning/self-adjusting and therefore provides relatively equal pressure across the skin surface through pivoting motion.

According to one example each flexible harness is padded.

According to one example each flexible harness has an outer cover, and a padding underneath the outer cover. The padding is configured to accommodate a user's knee and/or lower leg in a desirable soft and resilient and thereby comfortable manner. In another example, the outer cover itself is configured to provide the desired comfortability by adapting its thickness and resilience.

There is according to a second aspect of the present disclosure provided a wheelchair comprising a knee support assembly of the first aspect.

One embodiment comprises a leg rest assembly, wherein each base bracket assembly is mounted to the leg rest assembly.

According to one embodiment the wheelchair comprises a seating system with forward tilt and/or standing capability. Alternatively, the wheelchair may have a seating system without tilting or standing capability.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 shows a perspective view of an example of a knee support assembly for a wheelchair;

FIG. 2 shows a perspective view of the knee support assembly in FIG. 1 from the rear;

FIG. 3 is a rear view of the knee support assembly in FIG. 1;

FIG. 4 depicts a sectional view along lines A-A in FIG. 3;

FIG. 5 is a close-up view of a portion of the sectional view in FIG. 4;

FIG. 6 shows a harness holder when removed from the base bracket assembly;

FIG. 7 is a perspective view of an example of a flexible harness;

FIG. 8A shows a perspective view of the flexible harness in FIG. 7 with its outer cover removed;

FIG. 8B shows a perspective view of the flexible harness in FIG. 8A with further components removed;

FIG. 8C is a front view of an underside of the substrate of the flexible harness in FIG. 7 without padding;

FIGS. 9A-9B show perspective and top views of a knee support when being tightened and untightened, respectively;

FIG. 10 shows an example of a variation of the knee support assembly;

FIG. 11 depicts another example of a variation of the knee support assembly;

FIG. 12 shows a perspective view of a knee support and how it can accommodate different leg sizes and positions;

FIG. 13 is an example of a wheelchair comprising the knee support assembly;

FIG. 14 is a perspective view of a knee support assembly attached to a leg rest assembly; and

FIG. 15 shows a top view of a harness holder and the flexible harness in a parked position.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

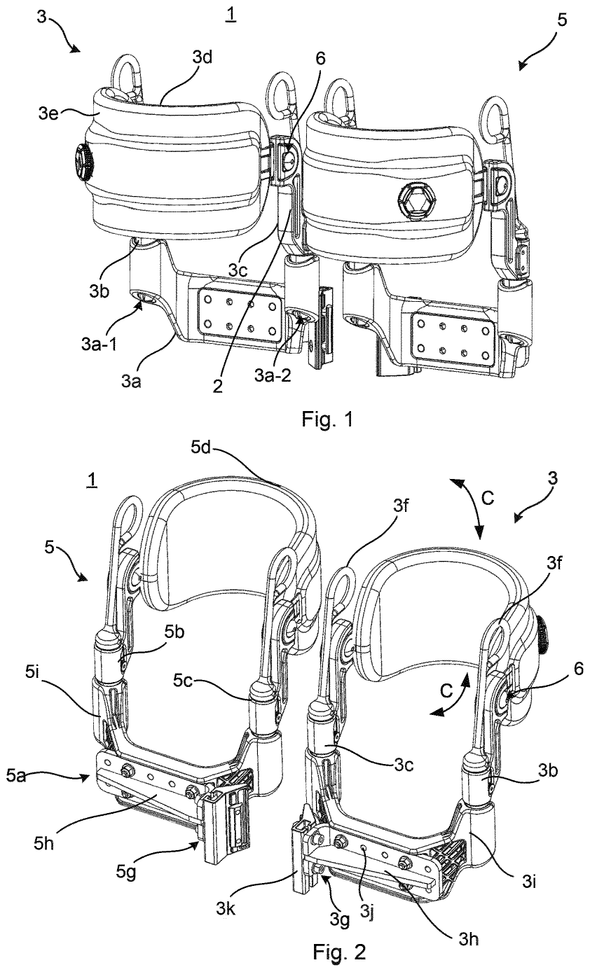

FIG. 1 depicts a knee support assembly 1. The knee support assembly 1 is configured to be mounted to a wheelchair, for example to a leg rest assembly or to the chassis of a wheelchair.

The knee support assembly 1 comprises a first knee support 3 and a second knee support 5. Each of the first knee support 3 and the second knee support 5 is arranged to support a respective knee and/or an upper portion of the lower leg of a user.

The first knee support 3 comprises a base bracket assembly 3a. The base bracket assembly 3a is configured to be mounted to a wheelchair, such as to a leg rest assembly of a wheelchair.

The first knee support 3 comprises a first harness holder 3b and a second harness holder 3c. Each of the first harness holder 3b and the second harness holder 3c may have an elongated structure, but other shapes are also contemplated.

The first harness holder 3b and the second harness holder 3c may have a respective lower portion that is connected to the base bracket assembly 3a.

According to one example, at least one of the first harness holder 3b and the second harness holder 3c is releasably connected to the base bracket assembly 3a. According to one example both the first harness holder 3b and the second harness holder 3c are releasably connected to the base bracket assembly 3a.

According to the example, the base bracket assembly 3a has two openings 3a-1 and 3a-2. Each opening 3a-1 and 3a-2 is configured to receive the lower portion of a respective one of the first harness holder 3b and the second harness holder 3c.

The openings 3a-1 and 3a-2 are arranged at a respective one of a first lateral side and a second lateral side of the base bracket assembly 3a.

Each of the first harness holder 3b and the second harness holder 3c comprises a respective harness connector arm 2. Each harness connector arm 2 extends from the base bracket assembly 3a, 5a when the harness holders 3b, 3c are connected to the base bracket assembly 3a.

The first knee support 3 comprises a flexible harness 3d. The flexible harness 3d is connected to and extends between the first harness holder 3b and the second harness holder 3c. The flexible harness 3d is suspended between the first harness holder 3b and the second harness holder 3c. The flexible harness 3d is connected to and suspended between the two harness connector arms 2.

The flexible harness 3d is pivotally connected, or configured to be pivotally connected, to the first harness holder 3b and to the second harness holder 3c. There is a pivot connection 6 between each end of the flexible harness 3d and a respective one of the first harness holder 3b and the second harness holder 3c. The flexible harness 3d is thus pivotable relative to the first harness holder 3b and the second harness holder 3d, as shown by arrows C in FIG. 2. The flexible harness 3d is arranged to support the knee and/or an upper portion of the lower leg of a user.

The flexible harness 3d may be padded. For example, the flexible harness 3d may have an outer cover 3e and a foam filling arranged inside the outer cover 3e. In other examples, the flexible harness 3d may have a thicker outer cover providing the desired padding structure, or the flexible harness 3d may be provided without padding.

The flexible harness 3d may be configured to enable adjustment of its size or tightness. This is typically done after the user has placed a knee between the base bracket assembly 3a and the flexible harness 3d to make the flexible harness 3d fit tightly to the user's anatomy but could alternatively be done before the user places the knee/legs between the base bracket assembly 3a and the flexible harness 3d, especially if the flexible harness 3d is arranged to provide coarse adjustment of the size or tightness.

The second knee support 5 has the same structure as the first knee support 3. However, according to one example, the base bracket assembly may be shared by the four harness holders 3b, 3c, 5b, 5c, i.e., the knee support assembly may comprise a single base bracket assembly common to all four harness holders 3b, 3c, 5b, 5c.

FIG. 2 shows a rear perspective view of the knee support assembly 1. The first knee support 3 is a right knee support and the second knee support 5 is a left knee support. The two second harness holders 3c and 5c are inner harness holders, arranged adjacent to each other. The two first harness holders 3b and 5b are outer harness holders. Hereto, the first harness holder 3b is arranged laterally outside the second harness holder 3c and the first harness holder 5b is arranged laterally outside the second harness holder 5c.

Each base bracket assembly 3a and 5a may comprise a bracket structure 3h, 5h, which can be connected to e.g., a leg rest assembly, and a base 3i, 5i attached to the bracket structure 3h, 5h. The first harness holder 3b and the second harness holder 3c is connected to the base 3i.

The lateral positioning of the base 3i, 5i relative to corresponding bracket structure 3h, 5h may according to one example be adjusted. Each bracket structure 3h, 5h may for example comprise a plurality of openings 3j, for screws or bolts, horizontally aligned arranged one after the other in a direction from the first harness holder to 3b to the second harness holder 3c. The base 3i, 5i may comprise openings which can be aligned with selected openings 3j for attachment of the base 3i, 5i to the bracket structure 3h, 5h at a desired position in the lateral direction.

Each base bracket assembly 3a and 5a may be height adjustable. Hereto, each base bracket assembly 3a and 5a may have a height adjustment mechanism 3g, 5g. The height adjustment mechanism 3g, 5g may for example comprise a rail structure 3k configured to be mounted fixed to e.g., a leg rest assembly 27, shown in FIG. 13, of a wheelchair, and to the bracket structure 3h, 5h. The bracket structure 3h, 5h may be configured to run vertically along the rail structure 3k. The bracket structure 5h may be fixated e.g., by screws or bolts to the rail structure 3k at a desired height. As an alternative, the rail structure may be provided on the leg rest assembly 27, with a bracket structure 3h, 5h mounted directly thereto.

At least one of the first harness holder 3b, 5b and the second harness holder 3c, 5c of each knee support 3, 5 may comprise a release member 3f. The release member will in the following be exemplified by pulling handle 3f that can be gripped by a user, and which is configured to be pulled along a longitudinal axis of the harness holder in question. According to the example shown in FIG. 2, both the first harness holder 3b and the second harness holder 3c are provided with a respective pulling handle 3f. By pulling the pulling handle 3f of the first harness holder 3b, the first harness holder 3b can be released from the base bracket assembly 3a. Similarly, by pulling the pulling handle 3f of the second harness holder 3c, the second harness holder 3c can be released from the base bracket assembly 3a. When one of the harness holders 3b, 3c has been released from the base bracket assembly 3a, the flexible harness 3d, 5d may be moved or folded to the side to enable a user to remove their knee or place their knee in a knee support 3, 5.

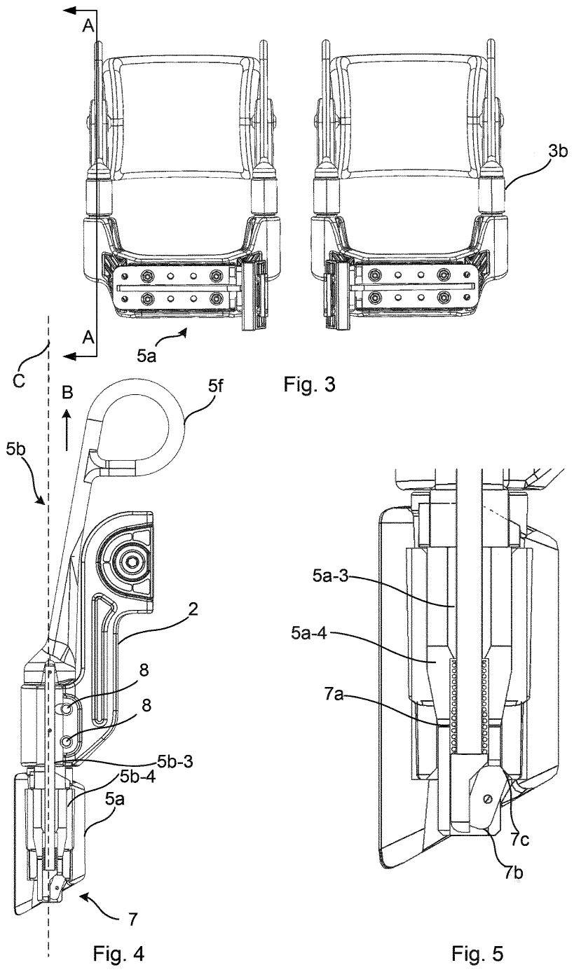

FIG. 3 shows a rear view of the knee support assembly 1. FIG. 4 shows a cross-section along lines A-A in FIG. 3. The cross-section thus shows the first harness holder 5b arranged in the base bracket assembly 5a of the second knee support 5. This configuration may according to one example apply to all the harness holders 3b, 3c, 5b, 5c.

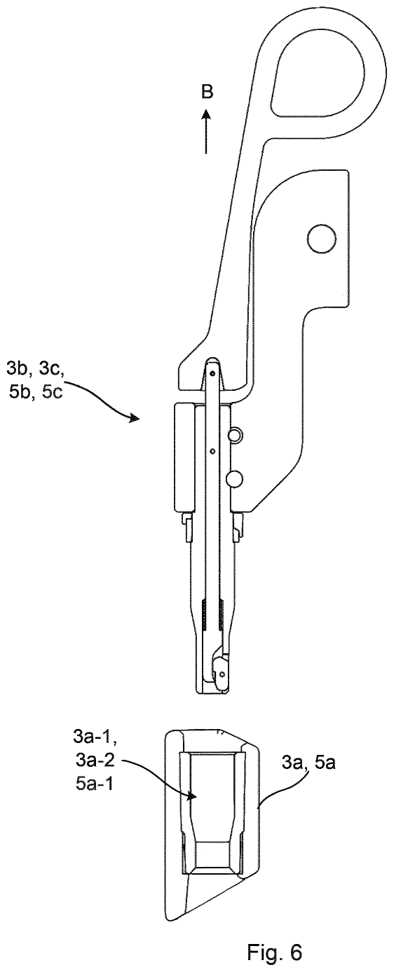

FIG. 4 depicts an example of the first harness holder 5b which is releasably connected to the base bracket assembly 5a. The first harness holder 5b comprises a locking mechanism 7 configured to releasably lock the first harness holder 5b to the base bracket assembly 5a. The first harness holder 5b has an inner rod 5b-3 and an outer stem 5b-4 arranged around the inner rod 5b-3. The inner rod 5b-3 is axially movable relative to the outer stem 5b-4. The inner rod 5b-3 and the outer stem 5b-4 are arranged to extend into an opening 5a-1 of the base bracket assembly 5a, shown in FIG. 6. As shown in more detail in FIG. 5, the exemplified locking mechanism 7 comprises a resilient element 7a, such as a spring, arranged around the inner rod 5b-2 and a spring-loaded element 7b. The resilient element 7a biases the spring-loaded element 7b towards a counter surface 7c of the base bracket assembly 5a, for example a bevelled surface, such that the spring-loaded element 7b engages with the base bracket assembly 5a and axially locks the first harness holder 5b to the base bracket assembly 5a. The pulling handle 5f also forms part of the locking mechanism 7. The pulling handle 5f forms an upper or top end of the first harness holder 5b. When pulled upwards in the direction of the arrow B along a longitudinal axis C of the first harness holder 5b, the inner rod 5b-c is initially moved axially upwards relative to the outer stem 5b-4 and thus the resilient member 7a is compressed towards a radial surface of the outer stem 5b-4 and the spring tension provided by the resilient element 7a on the spring-loaded element 7b decreases and the spring-loaded element 7b disengages from the base bracket assembly 5a. Eventually, during the operation of pulling out the first harness holder 5b from the base bracket assembly 5a, the inner rod 5b-3 will axially engage with the outer stem 5b-4 and they will move together in the direction of the arrow B. The spring-loaded element 7b may be arranged pivotable on the first harness holder 3b, for example on the outer stem 5a-4, wherein when the spring tension decreases, the spring-loaded element 7b pivots away from the counter surface 7c thus causing the first harness holder 3b to disengage from the base bracket assembly 3a. When no pulling force acts on the pulling handle 3f, the spring-loaded element 7b is pivoted towards the counter surface 7c by the force provided by the resilient member 7a locking the first harness holder 3b to the base bracket assembly 3a.

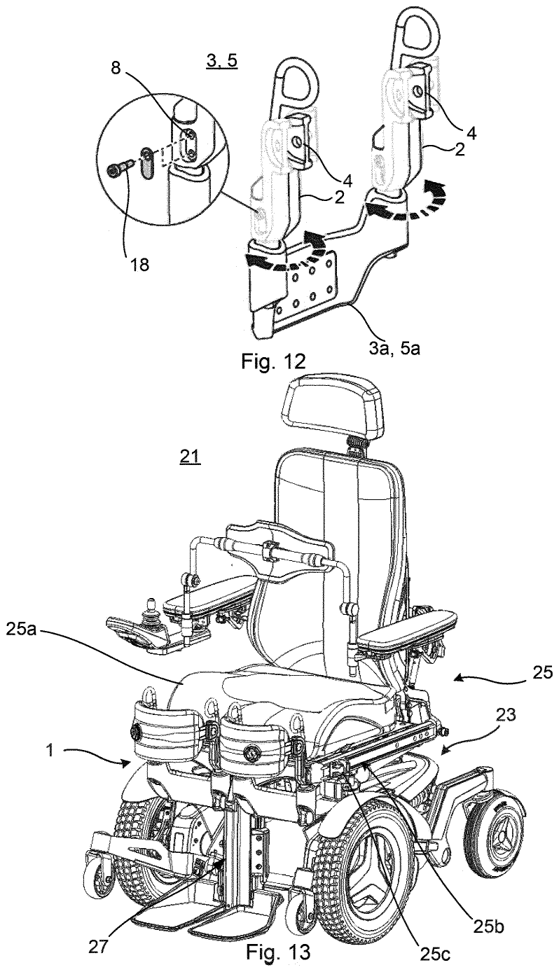

The harness connector arm 2 may comprise openings 8 configured to receive respective fasteners, such as shoulder bolts or screws, to thereby rotationally fix or release the harness connector arm 2 from the outer stem 5b-4, to set the rotational position of the harness connector arm 2 relative to the outer stem 5b-4 as will be explained in more detail with reference to FIG. 12.

FIG. 6 shows the harness holder 3b, 3c, 5b, 5c when it has been completely removed from the base bracket assembly 3a, 5a.

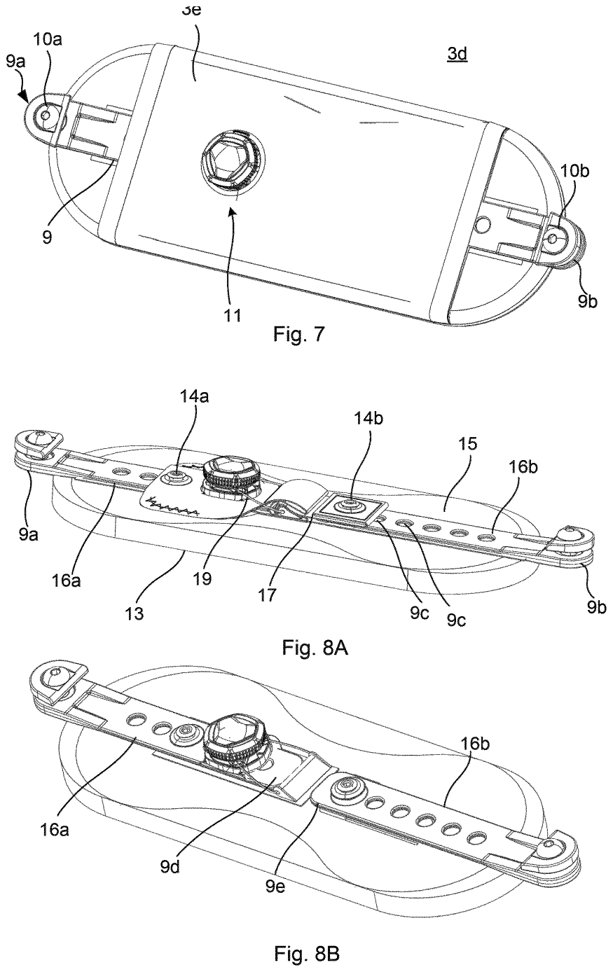

FIG. 7 shows a perspective view of the flexible harness 3d. The flexible harness 3d has a knee-facing side arranged to bear against the knee of a user, and an outer side.

The flexible harness 3d comprises a connection strap 9. The connection strap 9 is configured to be connected to the first harness holder 3b and the second harness holder 3c. The connection strap 9 has a first outer end 9a and a second outer end 9b opposite to the first end 9a. The flexible harness 3d may have an elongated shape, extending from the first outer end 9a to the second outer end 9b of the connection strap 9.

The flexible harness 3d may comprise connection elements 10a, 10b, such as screws, for releasably connecting the connection strap 9 and thus the flexible harness 3d to the first harness holder 3b and the second harness holder 3c, respectively, in a pivotable way.

The exemplified flexible harness 3d comprises an external knob 11. The external knob 11 is provided on the outer side of the flexible harness 3d. The external knob 11 forms part of a user-adjustable adjustment system configured to adjust the size/tightness of the flexible harness 3d.

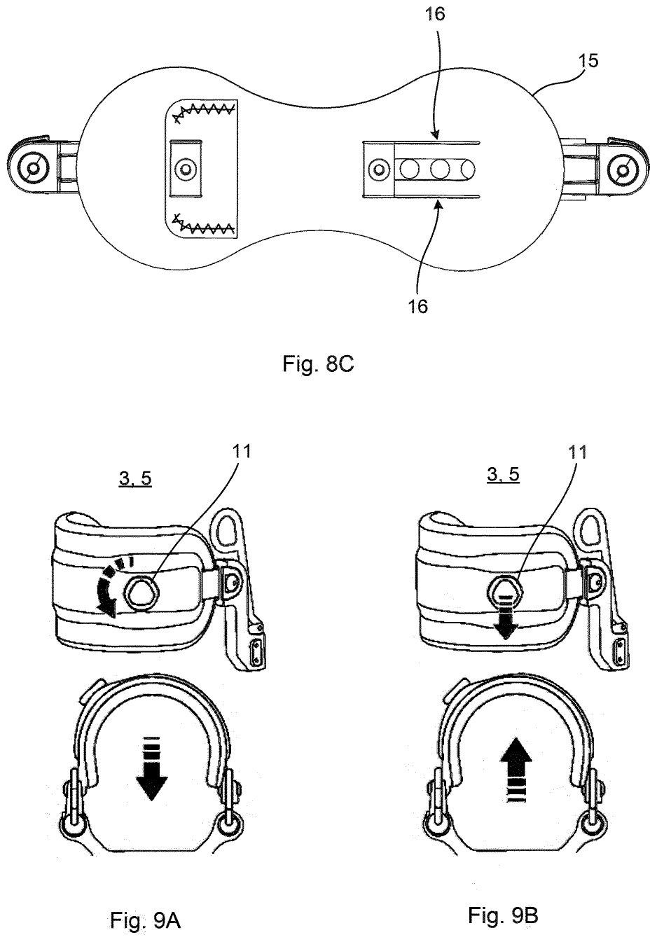

FIG. 8A shows the flexible harness 3d without its outer cover 3e. The flexible harness 3d may comprise a padding 13, for example a foam filling. When the flexible harness 3d is attached to the first harness holder 3b and the second harness holder 3c the flexible harness 3d obtains a curved state in which the outer side of the flexible harness 3d provided with the external knob 11 bulges outwards. The padding 13 is arranged on the knee-facing side of the flexible harness 3d. The padding 13 thus faces the knee of a user when the knee support assembly 1 is in use.

The flexible harness 3d comprises a substrate 15 onto which the connection strap 9 is mounted. The substrate 15 may be stiff or rigid. The substrate may for example be made of a polymeric, metal, or a composite material. The padding 13 may be mounted to the substrate 15.

As better seen in FIG. 8B, the connection strap 9 may be made of two separate strap pieces 16a and 16b. The adjustment system may also comprise a main strap 17 extending between the two strap pieces 16a and 16b of the connection strap 9. The main strap 17 connects the two strap pieces 16a, 16b of the connection strap 9. The main strap 17 thus bridges the two strap pieces 16a and 16b. A first of the strap pieces 16a may be arranged fixed relative to the substrate 15. A second of the strap pieces 16b may be arranged slidably relative to the substrate 15. For example, the second strap piece 16b may be slidably attached to slots 16 arranged in the substrate 15, as shown in FIG. 8C. Sliding of the second strap piece 16b relative to the first strap piece 16a changes the distance between facing inner ends 9d and 9e of the two strap pieces 16a and 16b and thus also the distance between the two outer ends 9a and 9b. The length of the connection strap 9 and thus the length of the flexible harness 3d can thereby be adjusted. This accommodates user knees and legs of different shapes and sizes.

The two strap pieces 6a, 16b may be provided with a plurality of through-openings 9c for attaching the strap pieces 16a, 16b to the substrate 15, for example by means of a respective fastener such as a screw 10a, e.g., a barrel screw, and nut. The size of the flexible harness 3d may thereby be adjusted. In particular, the sliding feature of the second strap piece 16b may provide a fine adjustment of the tightness of the flexible harness 3d, and the through-openings 9c and fasteners may form part of a coarse adjustment system providing a coarse adjustment of the size of the flexible harness 3d.

The adjustment system may comprise a wire, or lace, 19 which is connected to the main strap 17 and wound around the external knob 11. The external knob 11 may be attached to the first strap piece 16a. By twisting the external knob 11, the length of wire 19 extending from the external knob 11 can be set. The main strap 17 has an excess length with regards to the minimum distance between the two strap pieces 16a and 16b, such that when the external knob 11 is twisted, pushed, or pulled, the length of the main strap 17 can be adjusted and the movable second strap piece 16b can be pulled closer to the first strap piece 16a to tighten the flexible harness 3d or the second strap piece 16b can be allowed to move away from the first strap piece 16a to loosen the flexible harness 3d, based on the unwound length of the wire 19. Further, the excess length of the main strap 17 also has a safety function, ensuring that there is a strap between the two strap pieces 16a and 16b as an extra precaution preventing the flexible harness 3d to come apart.

FIG. 9A shows a perspective view and a top view of the knee support 3, 5, when the knee support 3, 5 is tightened by twisting the external knob 11. FIG. 9B shows a perspective view and a top view of the knee support 3, 5, when the knee support 3, 5 is untightened by pulling the external knob 11.

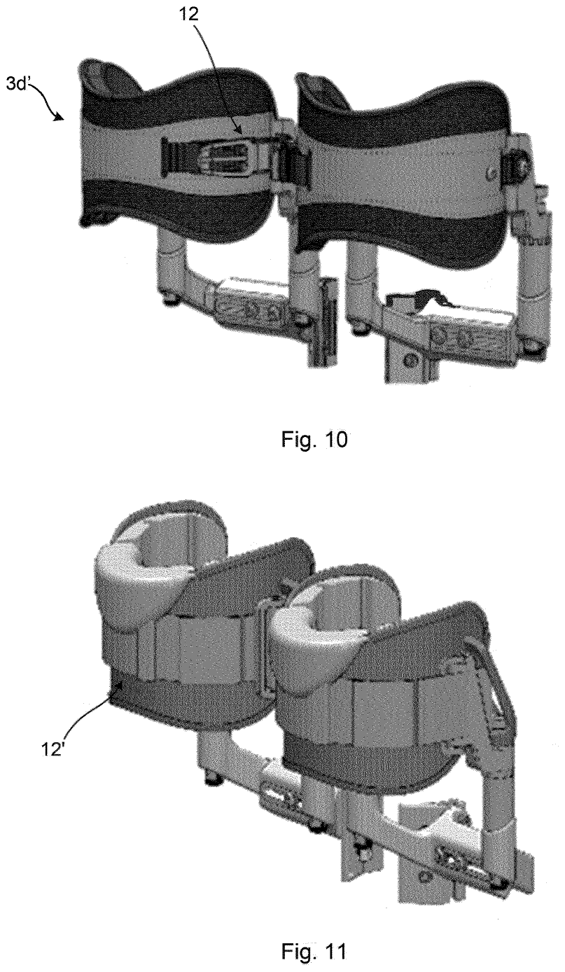

As shown in FIG. 10, the adjustment system of the flexible harness 3d′ may according to one example comprise a binding system 12 for example including a buckle, such as a ratchet buckle, and a binding strap instead of the external knob 11, or in addition to the external knob 11. The binding system 12 may be provided on the outside of the flexible harness. The adjustment system with the binding system 12 may provide fine adjustment of the tightness of the flexible harness 3d. As an alternative to the buckle, a tightening strap 12′ for example with a hook and loop structure, could be provided to adjust the tightness of the flexible harness, as shown in FIG. 11. The tightening strap may be arranged on the outside of the flexible harness.

With reference to FIG. 12, the rotational position of the harness connector arm 2 of the first harness holder 3b, 5b and/or the second harness holder 3c, 5c relative to the base bracket assembly 3a, 5a to which the harness holders 3b, 3c, 5b, 5c are connected, and relative to the respective outer stem 5b-4, may according to one example be adjusted. The harness connector arms 2 may be configured to be rotatable relative to the outer stem 5b-4, i.e., the lower portion of the harness holder 3b, 3c, 5b, 5c received in the base bracket assembly 3a, 5a. The harness connector arms 2 may be released from a fixed connection with a lower portion of the respective harness holder 3b, 3c, 5b, 5c such that each harness connector arm 2 can be rotated laterally inwards or outwards. Thereby, the pair of harness connector arms 2 of the flexible harness 3d can be rotated towards each other to reduce the distance between connection points 4 of the respective harness connector arm 2, or away from each other, to increase the distance between the connection points 4. Different knee and leg sizes may thus be accommodated. Additionally, both harness connector arms 2 may be rotated in the same direction to address the user's needs or desire for leg positioning, e.g., for users with non-symmetrical posture. In the disclosed example, the harness connector arm 2 is secured to the desired angular positions using a shoulder bolt 18 being fixed to one of a plurality of angle setting positions on the harness connector arm 2.

Each flexible harness 3d, 5d is arranged in front of the respective connection points 4, in a forward direction from the base bracket assembly 3a, 5a towards the flexible harness 3d, 5d. This means that the pivot connections of the connection points 4 and the connection elements 9a, 9b of the flexible harness 3d, 5d are arranged behind the knee joint when the knee support assembly 1 is in use. The flexible harness 3d, 5d will therefore better follow any movement of a knee.

With reference to FIG. 13, an example of a wheelchair 21 is shown. The wheelchair 21 is according to the example a power wheelchair but could alternatively be a manual wheelchair.

The exemplified wheelchair 21 comprises a chassis 23 and a seating system 25 comprising a seat 25a, attached to the chassis 23. The wheelchair 21 comprises a leg rest assembly 27 attached to the chassis 23 or to the seating system 25. The seating system 25 may have forward tilting and/or standing capability, for example by means of motor control. The seat 25a may thus according to one example be able to be tilted slightly forward, such that the user attains a forward leaning position, or according to another example, it may be tilted significantly forward, such that the user attains an essentially vertical stand position.

The wheelchair 21 comprises the knee support system 1. The knee support system 1 is according to the example attached to the leg rest assembly 27. For example, each base bracket assembly 3a, 5a e.g., by means of the rail structure 3k, may be attached to the leg rest assembly 27. In another example, the leg rest assembly 27 comprises a leg rest rail structure (not shown) for mounting of the knee support system 1, such that the knee support system 1 can be mounted to the leg rest assembly 27 at different vertical positions along the leg rest assembly 27.

The seating system 25 may comprise two laterally arranged rail structures 25b, one at each side of the seat 25a.

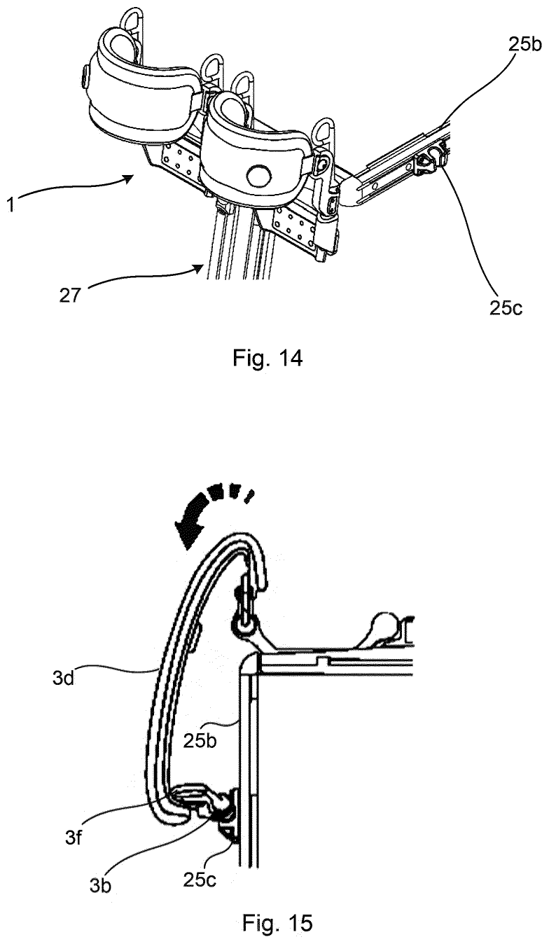

The seating system 25 may comprise anchoring members 25c, each anchoring member 25c being attached to a respective one of the two lateral rail structures 25a. Each first, or inner, first harness holder 3b, 5b is configured to be releasably attached to a respective one of the anchoring members 25c. In the disclosed example, the anchoring members 25 are free of any locking arrangements, and the harness holder 3b, 5b is simply introduced into the anchoring members from above and kept in place by gravity. The lateral rail structure 25b is shown in somewhat more detail in FIG. 14.

In another example, the anchoring member may be provided with locking features, for example by means of a locking mechanism such as locking mechanism 7. Then, the anchoring members 25c may have the same or similar design as the base bracket assembly 3a, 5a for axially interlocking with the second harness holders 3c, 5c.

FIG. 15 is top view of an example of the first knee support 3 when the first flexible harness 3d and the inner, or first, harness holder 3c, has been arranged in a parked position after the first harness holders 3c has been disengaged and removed from the base bracket assembly 3a and the flexible harness 3d has been moved outwards and been attached to the anchoring member 25c arranged adjacent to the first knee support 3.

The inventive concept has mainly been described above with reference to a few examples. However, as is readily appreciated by a person skilled in the art, other embodiments than the ones disclosed above are equally possible within the scope of the inventive concept, as defined by the appended claims.

1. A knee support assembly (1) for a wheelchair (21), comprising:
a knee support (3) comprising:
a base bracket assembly (3a) configured to be mounted to a wheelchair (21),
a first harness holder (3b) having a lower portion connected to the base bracket assembly (3a) at a first lateral side of the base bracket assembly (3a),
a second harness holder (3c) having a lower portion connected to the base bracket assembly (3a) at a second lateral side of the base bracket assembly (3a),
a flexible harness (3d) connected to and extending between the first harness holder (3b) and the second harness holder (3c), wherein the flexible harness (3d) is arranged to provide knee support,
wherein at least one of the first harness holder (3b) and the second harness holder (3c) is releasably connected to the base bracket assembly (3a), to enable moving the flexible harness to the side relative to the base bracket assembly (3a) and thereby allow placement or removal of a leg between the base bracket assembly (3a) and the flexible harness (3d).

2. The knee support assembly (1) as claimed in claim 1, wherein the knee support (3) is a first knee support and the knee support assembly (1) comprises a second knee support (5) comprising: a base bracket assembly (5a) configured to be mounted to a wheelchair (21), a first harness holder (5b) having a lower portion connected to the base bracket assembly (5a) at a first lateral side of the base bracket assembly (5a), a second harness holder (5c) having a lower portion connected to the base bracket assembly (5a) at a second lateral side of the base bracket assembly (5a), a flexible harness (5d) connected to and extending between the first harness holder (5b) and the second harness holder (5c), wherein the flexible harness (5d) is arranged to provide knee support, wherein at least one of the first harness holder (5b) and the second harness holder (5c) is releasably connected to the base bracket assembly (5a), to enable moving the flexible harness (5d) to the side relative to the base bracket assembly (5a) and thereby allow placement or removal of a leg between the base bracket assembly (5a) and the flexible harness (5d).

3. The knee support assembly (1) as claimed in claim 2, wherein the first knee support (3) is a right knee support, and the second knee support (5) is a left knee support.

4. The knee support assembly (1) as claimed in claim 3, wherein for each of the right knee support (3) and the left knee support (5), the first harness holder (3b, 5b) is an outer harness holder, and the second harness holder (3c, 5c) is an inner harness holder.

5. The knee support assembly (1) as claimed in claim 4, wherein each inner harness holder (3c 5c) is releasably connected to the respective base bracket assembly (3a, 5a).

6. The knee support assembly (1) as claimed in claim 2, wherein for each of the first and the second knee support (3, 5), both the first harness holder (3b, 5b) and the second harness holder (3c, 5c) is releasably connected to the respective base bracket (3a, 5a).

7. The knee support assembly (1) as claimed in claim 2, wherein for each knee support (3, 5), the at least one of the first harness holder (3b, 5b) and the second harness holder (3c, 5c) that is releasably connected to the base bracket assembly (3a, 5a) comprises a locking mechanism (7) configured to releasably lock said harness holder (3b, 3c, 5b, 5c) to the base bracket assembly (3a, 5a).

8. The knee support assembly (1) as claimed in claim 7, wherein the locking mechanism (7) comprises a spring-loaded element (7b) configured to engage with the base bracket assembly (3a, 5a), and a release member (3f) configured to disengage the spring-loaded element (7b) from the base bracket assembly (3a, 5a).

9. The knee support assembly (1) as claimed in claim 8, wherein the spring-loaded element (7b) is a pivotable element urged to pivot into engagement with the base bracket assembly (3a, 5a) by spring tension.

10. The knee support assembly (1) as claimed in claim 8, wherein the release member (3f) is a pulling handle (3f) configured to be pulled along a longitudinal axis (C) of said harness holder (3b, 3c, 5b, 5c) to decrease spring tension on the spring-loaded element (7b) and disengage the spring-loaded element (7b) from the base bracket assembly (3a, 5a).

11. The knee support assembly (1) as claimed in claim 2, wherein for each knee support (3, 5) the flexible harness (3d, 5d) comprises a user-adjustable adjustment system configured to adjust a size and/or a tightness of the flexible harness (3d, 5d).

12. The knee support assembly (1) as claimed in claim 11, wherein the adjustment system comprises an external knob (11), and a wire (19) connected to the external knob (11) and arranged inside the flexible harness (3d, 5d), wherein the external knob (11) is configured to adjust the length of the wire (19) by rotation, a push, or a pull of the external knob (11), causing an adjustment of a distance between opposite ends of the flexible harness (3d, 5d), configured to be connected to a respective one of the first harness holder (3b, 5b) and the second harness holder (3c, 5c), thereby adjusting the tightness of the flexible harness (3d, 5d).

13. The knee support assembly (1) as claimed in claim 12, wherein the adjustment system comprises a connection strap (9) comprising a first strap piece (16a) and a second strap piece (16b), each strap piece (16a, 16b) being configured to be connected to a respective one of the first harness holder (3b, 5b) and the second harness holder (3c, 5c), wherein one of the strap pieces (16b) is configured to slide axially relative to the other strap piece (16a), and wherein the adjustment system comprises a main strap (17) connecting and extending between the first and the second strap piece (16a, 16b), the main strap (17) having an excess length relative to a minimum distance between the first strap piece (16a) and the second strap piece (16b), wherein the first strap piece (16a) is connected to the external knob (11) and the main strap (17) is connected to the wire (19), and wherein the length of the wire (19) determines a distance between the two strap pieces (16a, 16b), and thereby the distance between the opposite ends of the flexible harness (3d, 5d).

14. The knee support assembly (1) as claimed in claim 11, wherein the adjustment system comprises a binding system (12) or a tightening strap for adjustment of the size or tightness of the flexible harness (3d, 5d).

15. The knee support assembly (1) as claimed in claim 11, wherein the adjustment system is a fine adjustment system providing fine adjustment of the distance, and wherein the knee support assembly (1) comprises a coarse adjustment system providing coarse adjustment of the distance.

16. The knee support assembly (1) as claimed in claim 2, wherein each flexible harness (3d, 5d) is pivotally connected to first harness holder (3b, 5b) and to the second harness holder (3c, 5c).

17. A wheelchair (21) comprising a knee support assembly (1) as claimed in claim 2.

18. The wheelchair (21) as claimed in claim 17, comprising a leg rest assembly (27), wherein each base bracket assembly (3a, 5a) is mounted to the leg rest assembly (27).

19. The wheelchair (21) as claimed in claim 17, wherein the wheelchair comprises a seating system (25) with forward tilt and/or standing capability.
